(19) United States
(12) Patent Application Publication
(10) Pub. No.: US 2024/0246502 A1
(43) Pub. Date: Jul. 25, 2024

(54) Vehicle Remote Safety Device Control System

(71) Applicant: Robert Bosch GmbH, Stuttgart (DE)

(72) Inventors: Matthew Peters, Ypsilanti, MI (US); Jonathan Freiman, Ann Arbor, MI (US)

(21) Appl. No.: 18/099,349

(22) Filed: Jan. 20, 2023

(51) Int. Cl. B60R 21/0134; A41D 13/018; B60R 21/013; B62J 45/20; G08C 17/02

(52) U.S. Cl. CPC B60R 21/0134; A41D 13/018; B60R 21/013; B62J 45/20; G08C 17/02; B60R 2021/0088

(57) ABSTRACT

A remote safety device control system for a vehicle that commands a remote safety device to activate in the event the remote safety device control system determines that a collision is imminent. The remote safety device control system receives safety information from one or more vehicle subsystems from which it determines whether a collision is imminent. If a collision is determined to be imminent, the remote safety device control system activates the remote safety device.

### TECHNICAL FIELD

This disclosure relates to a remote safety device control system for a vehicle (such as a motorcycle) that commands a remote safety device (such as an airbag-equipped garment worn by the vehicle operator) to activate in the event the remote safety device control system determines that a collision is imminent. The remote safety device control system receives safety information from one or more vehicle subsystems from which it determines whether a collision is imminent. If a collision is determined to be imminent, the remote safety device control system activates the remote safety device.

### BACKGROUND

Both airbag-equipped garments (also known as airbag vests) and vehicle advanced operator assistance systems—commonly known as Advanced Rider Assistance Systems (ARAS) for motorcycles and Advanced Driver Assistance Systems (ADAS) for cars and trucks—are well-known in the art.

An airbag-equipped garment is a vest-like garment worn by the operator of a motor vehicle (e.g., motorcycle). Such garments typically comprise an inflatable bladder and a canister of compressed gas. When the airbag of the garment is deployed, gas is released from the canister and into the bladder, thereby inflating the bladder. The airbag offers protection to the operator's body in the event of a collision. In this context, the term collision includes any impact between the vehicle or operator and an obstacle or the ground. The term obstacle includes any object (including other vehicles), whether stationary or in motion, with which the vehicle could collide, or which could collide with the vehicle. Conventional airbag-equipped garments may employ one or more known deployment mechanisms. For example, some airbag-equipped garments employ a wired or wireless (such as via ultra-wideband) tether, which causes the airbag to deploy when the garment is moved a certain distance from the vehicle (e.g., due to the operator being ejected from the vehicle). Additionally or alternatively, some airbag-equipped garments employ onboard sensors and electronics to determine whether a collision is occurring, in which event the airbag is deployed. However, conventional airbag-equipped garments do not receive commands from the vehicle.

Advanced operator assistance systems are electronic technologies that assist vehicle operators in driving functions. In general, advanced operator assistance systems use automated technology to detect nearby obstacles or potential driver errors, and respond accordingly. Examples of functionalities provided by conventional advanced operator assistance systems include lane keep assist, adaptive cruise control, forward collision warning, and automatic emergency breaking, among others. These technologies rely on environmental sensors (such as radar, lidar, ultrasonic, or image sensors) to ascertain the environment surrounding the vehicle, including obstacles and road markings. They may additionally rely on vehicle status information, which includes any operator inputs, to detect potentially unsafe conditions or situations. However, conventional advanced operator assistance systems do not send commands to remote safety devices.

Notably, the technology that exists on-vehicle as part of conventional advanced operator assistance systems is far more advanced that what exists on a conventional airbag-equipped garment. Factors including but not limited to size, weight, cost, and power consumption, render it impractical to outfit an airbag-equipped garment with all of the sensors and computing power that are present on the vehicle. Accordingly, on-vehicle advanced operator assistance systems, as a general matter, will predict collisions and other unsafe conditions and situations sooner and more accurately than the technology that exists on a conventional airbag-equipped garment. Accordingly, to maximize vehicle operator safety, there is a need for a remote safety device control system for a vehicle capable of activating a remote safety device, such as an airbag-equipped garment, in the event the system determines that a collision is imminent or occurring.

### SUMMARY

One aspect of this disclosure is directed to a remote safety device control system for a vehicle operated by an operator. The system comprises a controller, which receives safety information from one or more vehicle subsystems, and a gateway through which the controller is in communication with a remote safety device. The gateway may comprise a wireless transceiver or hardwired interface. Based at least in part on the safety information, the controller determines whether a collision is imminent, and if it determines that a collision is imminent, transmits via the gateway an activation command to the remote safety device. The vehicle may be a motorcycle. The remote safety device may be an airbag-equipped garment. The safety information may include distance and vehicle-relative speed data for one or more obstacles. The safety information may further include one or more of vehicle speed, longitudinal acceleration, lateral acceleration, roll rate, yaw rate, or pitch rate. The determination of whether a collision is imminent may be based in part on whether a minimum deceleration time exceeds an estimated time to collision.

A further aspect of this disclosure is directed to a method of operating a vehicle, comprising generating safety information in a vehicle subsystem; communicating the safety information to a remote safety device control system on the vehicle; determining with a controller of the remote safety device control system based on the safety information whether a collision is imminent; and, if a collision is determined to be imminent, transmitting from the controller via a gateway an activation command to a remote safety device. As above, the gateway may comprise a wireless transceiver or hardwired interface. The vehicle may be a motorcycle. The remote safety device may be an airbag-equipped garment. The vehicle subsystems may include one or more of an operator input subsystem, an instrument subsystem, an inertial measurement unit (IMU), an anti-lock brake system (ABS), or an environmental awareness subsystem. The safety information may include distance and vehicle-relative speed data for one or more obstacles. The safety information may further include one or more of vehicle speed, longitudinal acceleration, lateral acceleration, roll rate, yaw rate, or pitch rate. Additionally, the step of determining whether a collision is imminent may include determining whether a minimum deceleration time exceeds an estimated time to collision.

The above aspects of this disclosure and other aspects will be explained in greater detail below with reference to the attached drawings.

### BRIEF DESCRIPTION OF THE DRAWINGS

FIG. 1 is a functional block diagram of a vehicle equipped with a remote safety device control system according to the present invention.

FIG. 2 is a flow chart of an exemplary routine executed by a remote safety device control system to determine whether a forward collision is imminent.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

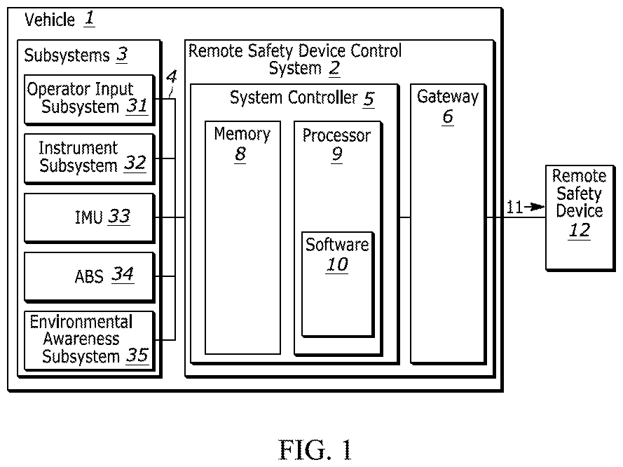

As shown in FIG. 1, a vehicle 1, such as a motorcycle, equipped with a remote safety device control system 2 comprises multiple vehicle subsystems 3. The vehicle subsystems 3 are not part of the remote safety device control system 2, but are in communication with it. Examples of such vehicle subsystems 3 include an operator input subsystem 31, an instrument subsystem 32, an inertial measurement unit (IMU) 33, an anti-lock brake system (ABS) 34, and an environmental awareness subsystem 35. All of these vehicle subsystems 3 generate safety information 4, some or all of which is shared with the remote safety device control system 2 and preferably the other subsystems 3. The specific safety information 4 generated and shared by each subsystem 3 depends on its function.

For example, the operator input subsystem 31 monitors operator input devices on the vehicle, including the throttle and brake, and generates safety information 4 including throttle position and brake position. Likewise, the instrument subsystem 32 includes instruments such as a speedometer and tachometer and generates safety information 4 including vehicle speed and engine revolutions per minute (RPM). The IMU 33 includes, for example, accelerometers and gyroscopes, and generates safety information 4 including vehicle longitudinal acceleration, lateral acceleration, roll rate, yaw rate, pitch rate, and lean angle. The ABS 34 includes, for example, wheel speed sensors and generates safety information 4 including a wheel speed and slip ratio for each wheel of the vehicle. Finally, the environmental awareness subsystem 35 includes sensors such as radar sensors and a camera, and generates safety information 4 including the distance and vehicle-relative speed of obstacles with which the vehicle 1 could collide, or which could collide with the vehicle 1. Another example of a vehicle subsystem 3 is an engine management system (EMS) (not shown). Importantly, the specific subsystems 3 noted here are exemplary, as is the specific safety information 4 generated by each vehicle subsystem 3. In some instances, a vehicle subsystem 3 may generate safety information 4 that includes a probability of collision or an indication that a collision is imminent. Likewise, a vehicle subsystem may include impact sensors and generate safety information 4 indicating that a collision has already occurred or is in progress (which initial collision between the vehicle and an obstacle may lead to further collisions between the operator and the obstacle or the ground). Moreover, while not generally referred to herein as such, the remote safety device control system 2 is itself an example of a vehicle subsystem 3. Preferably, it is separate from the operator input subsystem 31, the instrument subsystem 32, the IMU 33, the ABS 34, and the environmental awareness subsystem 35. However, it may optionally be integrated with any of those.

Each of the vehicle subsystems 3 comprises one or more sensors, one or more controllers, or, preferably, a combination thereof. In this context, a sensor is a device that converts a physical phenomenon into an electrical signal. A controller is an electronic device comprising a processor, memory, and data inputs and outputs. Within a given subsystem 3, a sensor and controller may be integrated into the same device, or may be separate devices. As used herein, the term sensor may refer to sensors with an integrated controller. Likewise, the term controller may refer to a controller with one or more an integrated sensors. For vehicle subsystems 3 consisting of sensors but no controller, the safety information 4 generated would be the raw sensor data. Vehicle subsystems 3 consisting of a controller without sensors receive safety information 4 from other subsystems 3 and use it to generate further safety information 4. As noted, the vehicle subsystems 3 share the safety information 4 they generate with each other and with the remote safety device control system 2. Such sharing is preferably done by way of a CAN (Controller Area Network) bus, but may be done via any suitable interface.

As further shown in FIG. 1, the remote safety device control system 2 preferably consists of a printed-circuit board (PCB) (not shown) on which various components are mounted including a system controller 5 and gateway 6. The system controller 5 and gateway 6 may be integrated into the same device or be separate devices. When separate, they may be mounted on the same PCB or on different PCBs. The system controller 5 includes memory 8 and a processor 9 on which software 10 is executed. The memory 8 may comprise one or multiple devices and preferably includes volatile RAM (random-access memory) and non-volatile flash memory. The memory 8 devices may be integrated into the same device as the processor 9, or may be separate devices. The software 10 to be executed on the processor 9 is preferably stored in the flash memory and loaded into RAM prior to execution. The system controller 5 preferably includes a CAN interface (not shown) through which it receives safety information 4 from the vehicle subsystems 3.

As described in more detail below, the software 10 of the system controller 5 analyzes the safety information 4 to determine whether a collision is imminent. If the software 10 determines that a collision is imminent, it sends an activation command 11, via the gateway 6, to a remote safety device 12. Preferably, the gateway 6 is a wireless transceiver. The gateway 6 is preferably paired with a corresponding transceiver (not shown) on the remote safety device 12 via Bluetooth (or another suitable wireless standard), for bidirectional wireless communication, with the remote safety device control system 2 as master and the remote safety device 12 as slave. Alternatively, the gateway 6 is a hardwired interface (e.g., Universal Serial Bus, CAN, or digital signal connection), which provides for bidirectional hardwired communication, with the remote safety device control system 2 as host and the remote safety device 12 as peripheral. Upon receiving the activation command 11 (which may comprise one or more Bluetooth data packets, USB messages, activation of a digital signal, or any suitable wired or wireless communication data unit) from the remote safety device control system 2, the remote safety device 12 immediately deploys its safety feature. For example, an airbag-equipped garment would immediately inflate its airbag. After deploying its safety feature, the remote safety device 12 sends a confirmation message (or digital signal) back to the remote safety device control system 2, which is received via the gateway 6.

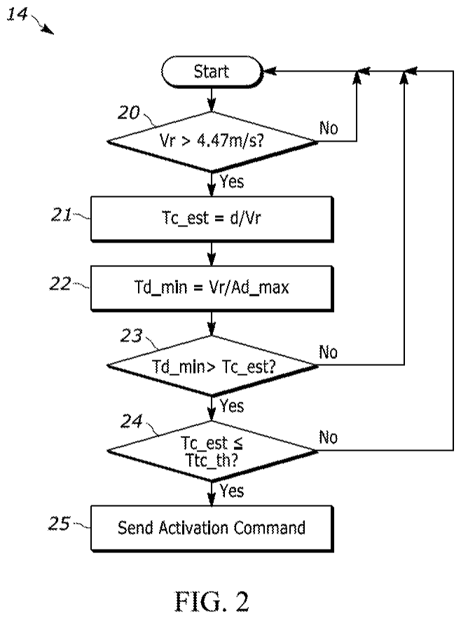

FIG. 2 is a flow chart of a routine 14 performed by the software 10 to determine whether a forward collision is imminent. As inputs, the routine 14 receives from the environmental awareness subsystem 35 the distance (d) and relative velocity (Vr) of obstacles ahead of and in the path of the vehicle 1. First, at step 20, the routine 14 checks whether the vehicle 1 is gaining on the obstacle by at least 10 mph, i.e. whether Vr is greater than 4.47 m/s. If Vr is less than 4.47 m/s, the remote safety device control system 2 will not activate the remote safety device 12, and the routine 14 stars over. On the other hand, if Vr is greater than 4.47 m/s, the routine continues to step 21 and calculates an estimated time to collision (Tc_est) according to the formula Tc_est=d/Vr. Next, at step 22, the routine calculates a minimum deceleration time (Td_min) to avoid colliding with the obstacle according to the formula Td_min=Vr/Ad_max, where Ad_max is the maximum safe deceleration value of 10 m/s\hat{ }2. Next, at step 23, the routine 14 checks if Td_min is greater than Tc_Est, i.e. whether the time to stop the vehicle 1 is greater than the time to collision, such that a collision is likely. If not, the routine starts over. Otherwise, at step 24, the routine 14 checks if Tc_est is less than or equal to a predetermined time to collision threshold (Ttc_th). In the disclosed embodiment, Ttc_th is 250 ms, based on the estimated CAN bus latency, activation command transmission latency, remote safety device activation latency, and other factors. However, this value may differ for each vehicle 1 and remote safety device 12 pair. At step 24, if Tc_est>Ttc_th, the time to collision threshold has not been met (i.e., it is too early to activate the remote safety device), and the routine starts over. Otherwise, a collision is deemed imminent, and the routine proceeds to step 25, sending an activation command 11 via the gateway 6 to the remote safety device 12.

Notably, the routine depicted in FIG. 2 is merely exemplary of one routine performed within the software 10 to determine whether a collision is imminent. Li practice, there are many other types and causes of collisions—a forward collision being only one of those—other examples being a rear-end collision, a rollover, etc. Preferably, the software 10 has specialized routines for multiple different collision types and causes, which run in parallel on the system controller 5. Optionally, the software 10 includes a routine that determines whether a collision is imminent based on safety information 4 from a vehicle subsystem 3 indicating the imminence or likelihood of a collision, such as via binary flag indicating that a collision is occurring or imminent or a numerical value representing the likelihood of a collision which the software 10 compares to a threshold.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts. For example, applicability of the present invention is not limited to motorcycles, but also includes any type of vehicle including cars, trucks, all-terrain vehicles, etc. Likewise, the applicability of the present invention is not limited to the control of airbag-equipped garments, but also with any other remote safety device, i.e. any safety device that is not integrated with the vehicle, including any safety-related garments or other wearables for vehicle operators or passengers. Finally, the present invention does not exclude that a remote safety device under the control of the present invention is also self-activating via its own sensors and electronics.

What is claimed is:

1. A remote safety device control system for a vehicle operated by an operator, comprising:
a controller, wherein the controller receives safety information from one or more vehicle subsystems, and
a gateway through which the controller is in communication with a remote safety device,
wherein, based at least in part on the safety information, the controller determines whether a collision is imminent, and if it determines that a collision is imminent, transmits via the gateway an activation command to the remote safety device.

2. The control system of claim 1, wherein the vehicle is a motorcycle.

3. The control system of claim 2, wherein the remote safety device is an airbag-equipped garment.

4. The control system of claim 3, wherein the safety information includes distance and vehicle-relative speed data for one or more obstacles.

5. The control system of claim 4, wherein the safety information includes one or more of vehicle speed, longitudinal acceleration, lateral acceleration, roll rate, yaw rate, or pitch rate.

6. The control system of claim 5, wherein the determination of whether a collision is imminent is based in part on whether a minimum deceleration time exceeds an estimated time to collision.

7. The control system of claim 6, wherein the gateway comprises a wireless transceiver.

8. The control system of claim 6, wherein the gateway comprises a hardwired interface.

9. A method of operating a vehicle, comprising:
generating safety information in a vehicle subsystem;
communicating the safety information to a remote safety device control system on the vehicle;
determining with a controller of the remote safety device control system based on the safety information whether a collision is imminent; and,
if a collision is determined to be imminent, transmitting from the controller via a gateway an activation command to a remote safety device.

10. The method of claim 9, wherein the vehicle is a motorcycle.

11. The method of claim 10, wherein the remote safety device is an airbag-equipped garment.

12. The method of claim 11, wherein the vehicle subsystems include one or more of an operator input subsystem, an instrument subsystem, an inertial measurement unit (IMU), an anti-lock brake system (ABS), or an environmental awareness subsystem.

13. The method of claim 12, wherein the safety information includes distance and vehicle-relative speed data for one or more obstacles.

14. The method of claim 13, wherein the safety information includes one or more of vehicle speed, longitudinal acceleration, lateral acceleration, roll rate, yaw rate, or pitch rate.

15. The method of claim 14, wherein the step of determining whether a collision is imminent includes determining whether a minimum deceleration time exceeds an estimated time to collision.

16. The method of claim 15, wherein the gateway comprises a wireless transceiver.

17. The method of claim 15, wherein the gateway comprises a hardwired interface.
